(19) United States
(12) Patent Application Publication
(10) Pub. No.: US 2026/0237220 A1
(43) Pub. Date: Aug. 13, 2026

(54) SYSTEM AND METHOD FOR OBJECT ASSOCIATION IN SURROUNDING VIEW CAMERAS

(71) Applicant: Torc Robotics, Inc., Blacksburg, VA (US)

(72) Inventors: Tianyi Yang, Austin, TX (US); Dalong Li, Troy, MI (US)

(21) Appl. No.: 19/050,341

(22) Filed: Feb. 11, 2025

(51) Int. Cl. G06V 20/58; G06V 10/25; G06V 10/26; G06V 10/62

(52) U.S. Cl. CPC G06V 20/58; G06V 10/25; G06V 10/26; G06V 10/62; G06V 2201/08

(57) ABSTRACT

A system is configured to: (i) perform object detection to identify and detect one or more objects in each image frame captured by each camera of a plurality of cameras; (ii) perform forward tracking and backward tracking for each image frame captured by each camera of the plurality of cameras; (iii) identify and associate objects in each image frame with objects in other frames, for each camera of the plurality of cameras, using a respective bidirectional re-identification (ReID) of each object of the objects; (iv) crop each object of the objects being tracked using the respective bidirectional ReID; (v) generate feature embeddings representing visual characteristics of each cropped object; (vi) generate and update a ranking score for each cropped object based upon the generated feature embeddings for each cropped object; and (vii) based upon the ranking score for each cropped object, associate objects in each image frame.

### TECHNICAL FIELD

The field of the disclosure relates generally to computer-vision and machine learning, and in particular to a system and a method for multiple camera tracking and re-identification (ReID) of objects in images captured using multiple cameras at different times.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technologies use multiple cameras to collect data about environment of the autonomous vehicle. Various objects in the environment of the autonomous vehicle need to be identified. Perception technologies use machine learning algorithms trained using images stored in a database. Generally, the images stored in the database are annotated manually. Such manual annotation of the images in the database is a very time consuming and expensive task. Further, manual annotation is error-prone due to subjective nature of the task.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system including at least one memory configured to store machine executable instructions, and at least one processor coupled to the at least one memory is disclosed. The at least one processor is configured to execute the machine executable instructions to: (i) perform object detection to identify and detect one or more objects in each image frame captured by each camera of a plurality of cameras; (ii) perform forward tracking and backward tracking for each image frame captured by each camera of the plurality of cameras; (iii) identify and associate objects in each image frame with objects in other frames, for each camera of the plurality of cameras, using a respective bidirectional re-identification (ReID) of each object of the objects; (iv) crop each object of the objects being tracked using the respective bidirectional ReID; (v) generate feature embeddings representing visual characteristics of each cropped object; (vi) generate and update a ranking score for each cropped object based upon the generated feature embeddings for each cropped object; and (vii) based upon the ranking score for each cropped object, associate objects in each image frame captured by each camera of the plurality of cameras.

In another aspect, a computer-implemented method is disclosed. The computer-implemented method includes (i) performing object detection to identify and detect one or more objects in each image frame captured by each camera of a plurality of cameras; (ii) performing forward tracking and backward tracking for each image frame captured by each camera of the plurality of cameras; (iii) identifying and associating objects in each image frame with objects in other frames, for each camera of the plurality of cameras, using a respective bidirectional re-identification (ReID) of each object of the objects; (iv) cropping each object of the objects being tracked using the respective bidirectional ReID; (v) generating feature embeddings representing visual characteristics of each cropped object; (vi) generating and updating a ranking score for each cropped object based upon the generated feature embeddings for each cropped object; and (vii) based upon the ranking score for each cropped object, associating objects in each image frame captured by each camera of the plurality of cameras.

In yet another aspect, an autonomous vehicle including a plurality of image sensors, at least one memory configured to store machine executable instructions, and at least one processor coupled to the at least one memory is disclosed. The at least one processor is configured to execute the machine executable instructions to: (i) perform object detection to identify and detect one or more objects in each image frame captured by each image sensor of the plurality of image sensors; (ii) perform forward tracking and backward tracking for each image frame captured by each image sensor of the plurality of image sensors; (iii) identify and associate objects in each image frame with objects in other frames, for each image sensor of the plurality of image sensors, using a respective bidirectional re-identification (ReID) of each object of the objects; (iv) crop each object of the objects being tracked using the respective bidirectional ReID; (v) generate feature embeddings representing visual characteristics of each cropped object; (vi) generate and update a ranking score for each cropped object based upon the generated feature embeddings for each cropped object; and (vii) based upon the ranking score for each cropped object, associate objects in each image frame captured by each image sensor of the plurality of image sensors.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is a block diagram of an example multiple camera tracking and ReID system;

FIG. 5 is a flow-chart illustrating an example process of single camera MOT using ByteTrack;

FIG. 6 is a diagram illustrating an example process of single camera MOT using ByteTrack for bidirectional ReID;

FIG. 7 illustrates an example ReID improvement or association;

FIG. 8 illustrates an example process of multiple camera ReID;

FIG. 9 illustrates a set of images for two different objects captured using a plurality of cameras at different times; and

FIG. 10 is a flow-chart of an example method of object association in a plurality of images captured by a plurality of cameras.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

An ego vehicle: An ego vehicle is a vehicle equipped with sensors such as, one or more camera sensors, one or more light detection and ranging (LiDAR) sensors, one or more radio detection and ranging (RADAR) sensors, etc., for collecting sensor data for various purposes including, but not limited to, training, testing, or validation.

Currently known tracking systems demonstrate a relatively high level of proficiency in tracking multiple objects within a single camera's field of view. A few of the currently known systems are capable of effectively tracking objects across multiple cameras. While associating objects of the same identify within a close range is plausible in the field of multiple camera re-identification (ReID), associating objects is often constrained by the resolution of target images. Various embodiments as described herein overcome these limitations by enabling tracking of multiple objects across an array of surrounding cameras, and, thereby, providing comprehensive 360-degree coverage.

Association is a key component in perception for self-driving cars. Following object detection, objects are associated before they can be fused and used. In the present disclosure, various aspects correspond with associating objects in surrounding view cameras over time. Objects are detected and tracked in each camera individually, and then all the tracked objects from all the cameras are cropped, indexed, and matched in deep neural network (DNN) features space. As described herein, tracking is an association based on motion, which is generally insufficient. Tracking may also be performed using image features to match the objects based on appearance. The disclosed systems and methods employ both motion and appearance to reliably associate, fuse, and use objects in an ego vehicle for driving functions, e.g., to adjust speed according to posted speed limit.

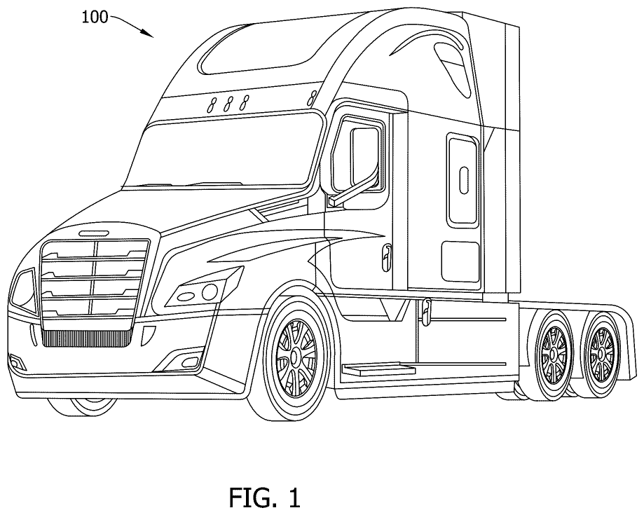

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

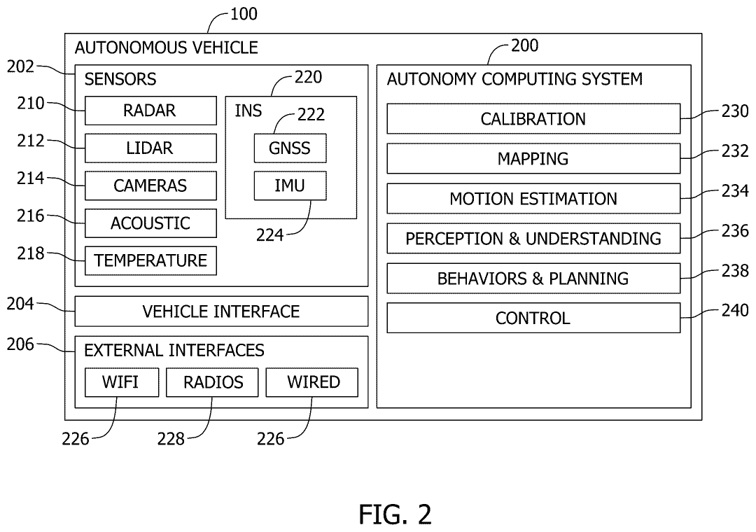

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

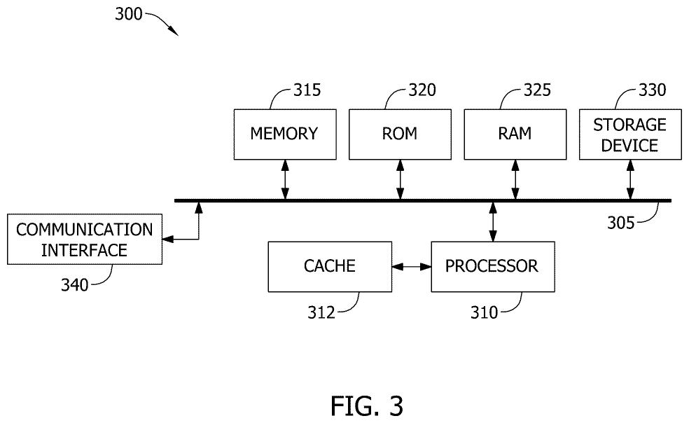

FIG. 3 illustrates an example computing system 300 that can implement various techniques, processes, functions, or methods described herein. Computing system 300 may be embodied within, for example, autonomous vehicle 100 shown in FIG. 1. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

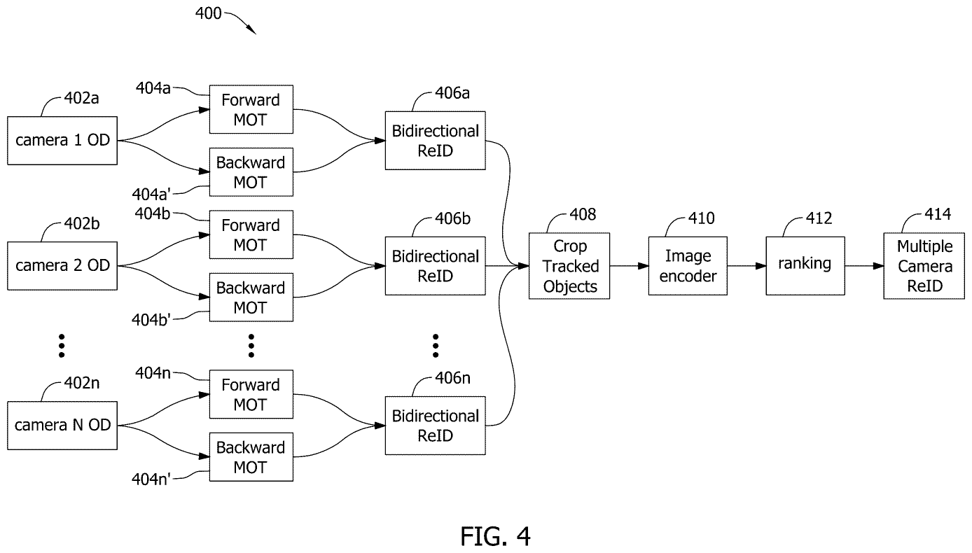

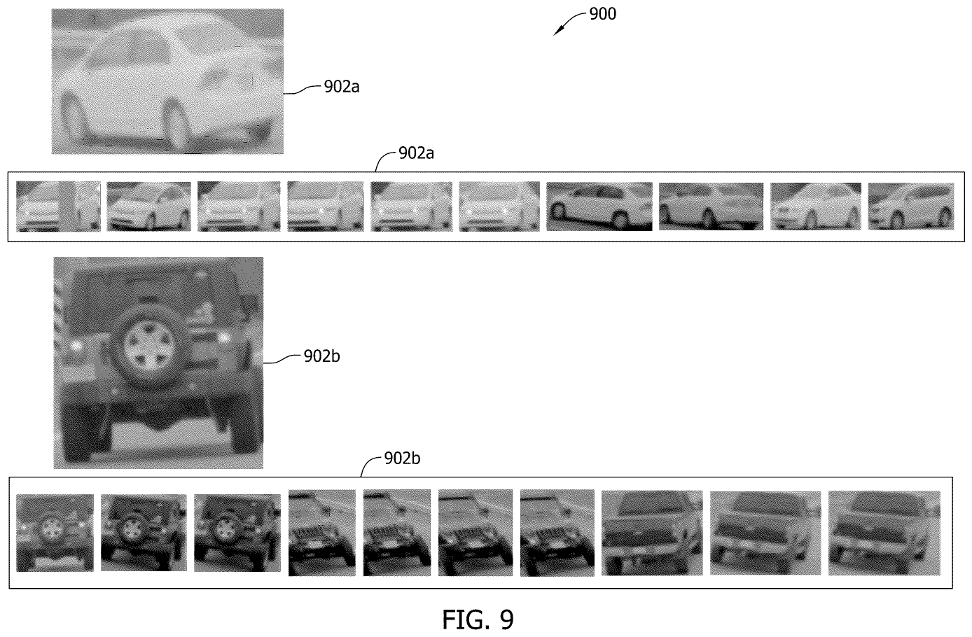

FIG. 4 is a block diagram of an example multiple camera tracking and ReID system 400. The system 400 may include a plurality of cameras 402a, 402b, . . . , 402n, with each camera of the plurality of cameras capturing a plurality of images (for example, shown in FIG. 9). The plurality of images captured using each of the plurality of cameras 402a, . . . , 402n are processed by a forward multiple object tracking (MOT) and backward MOT modules such as, 404a and 404a′, 404b and 404b′, . . . , 404n and 404n′, respectively. By way of an example, each MOT module, such as the forward MOT module and backward MOT module, leverages ByteTrack for efficient and accurate object tracking within individual camera views. MOT thus estimates bounding boxes and identities of objects in multiple images based upon obtaining identities by associating bounding boxes having scores that meets a particular threshold condition (e.g., a detection score of at least a predetermined threshold value). The objects with low detection scores, e.g., occluded objects, are ignored because the objects with low detection scores generally cause fragmented trajectories.

Output of each of the forward MOT module and the backward MOT module such as, 404a and 404a′, . . . , 404n and 404n′, is processed by a respective bidirectional ReID network such as, 406a, . . . , 406n. Each of the respective bidirectional ReID network 406a, . . . , 406n retrieves the same object across multiple spatially disjoint camera views. Due to image changes between cameras caused by various factors such as position variation and illumination transformation, images of different objects may appear more similar than multiple images of the same object. Additionally, a task of discriminative representations to distinguish details of different objects requires substantial computation for object ReID.

Many existing methods used for discriminative representations require cumbersome expert human annotations or complex network designs. However, bidirectional ReID networks 406a, . . . , 406n explore discriminative representations for object ReID without human annotations or complex network designs. Each bidirectional ReID network of 406a, . . . , 406n associates tracked objects within same camera views by matching their position from both forward and backward sequences, which are determined or identified based upon each of the forward MOT module and the backward MOT module such as, 404a and 404a′, . . . , 404n and 404n′.

Output of each bidirectional ReID network 406a, . . . , 406n, is processed for cropping each object, or objects having particular characteristics, using a cropping module (also referenced herein as a crop tracked objects module) 408. The cropping module 408 is based upon one or more object detection algorithms including, but not limited to, Ultralytics, YOLO11, etc. The one or more object detection algorithms involve isolating and extracting specific detected objects from each image (or a video frame). Accordingly, the one or more object detection algorithms are used to accurately identify and delineate objects, enabling precise cropping for further analysis or manipulation. Output of the cropping module 408 is fed as an input to an image encoder 410.

The image encoder 410 processes images from the plurality of cameras 402a, 402b, . . . , 402n to generate feature embeddings representing the visual characteristics of the tracked objects in the output of the cropping module 408. As described herein, feature embeddings transform complex, high-dimensional categorical data into a lower-dimensional vector representation while preserving important relationships between data points. In other words, raw features in the output of the cropping module 408 are converted into a meaningful numerical format that can be used by machine learning algorithms.

A ranking module 412 (also referenced herein as a reranking module 412) that refines the initial ReID results by reranking the matches based on the similarity of their feature embeddings based on output of the image encoder 410. Further, a multi-camera ReID module 414 integrates the reranked results by the ranking module 412 to associate objects across the plurality of cameras 402a, . . . , 402n, and provide a comprehensive tracking solution. The image encoder 410 is described in more detail below.

The image encoder 410 (shown in FIG. 4) is derived from the Contrastive Language-Image Pretraining (CLIP) image encoder. CLIP image encoder is pre-trained on a diverse dataset comprising 400 million image-text pairs from various sources for learning a wide range of visual concepts and contextual relationships. The architecture of the CLIP image encoder is built upon the Vision Transformer (ViT), which leverages self-attention mechanisms to capture complex relationships within image data. The ViT processes input images as a sequence of patches, allowing the machine learning model (or a neural network-based model) to learn global context and fine-grained details simultaneously.

The ViT architecture includes multiple transformer layers. Each transformer layer of the multiple transformer layers includes multi-head self-attention and feed-forward neural networks. This structure enables effective encoding of complex image features. In some examples, to enhance the CLIP image encoder's ability to capture vehicle features and distinguish between different vehicle identities, the CLIP image encoder is further fine-tuned on the PKU VehicleID dataset including many vehicle images with corresponding labels, providing a rich source of data for training the CLIP image encoder to recognize subtle differences between vehicles.

In traditional single-camera MOT systems, only motion information is leveraged for tracking. However, using only motion information for tracking can lead to inaccuracies, especially in scenarios with similar motion patterns. The fine-tuned CLIP image encoder addresses this limitation by incorporating contextual visual features into the tracking process, and thereby enhancing accuracy of identifying and re-identifying vehicles across multiple camera views.

The bi-directional tracking output undergoes a post-processing stage to further refine the tracking results, for example, by object cropping and motion blurring and truncation filtering. As described herein, each tracked object is cropped according to its tracked bounding box. Motion blurring and truncation filtering corresponds with a filtering mechanism applied to exclude instances affected by motion blur or truncation to ensure that only high-quality, clear images are used for association, thereby, improving the accuracy of cropped instance re-identification.

The incorporation of the fine-tuned CLIP image encoder into the multi-camera tracking system represents a significant advancement. By combining motion information with contextual visual features, the system achieves a higher level of accuracy and reliability in tracking and re-identifying objects across multiple camera views, which is particularly beneficial in applications such as vehicle surveillance, traffic monitoring, and intelligent transportation systems, where precise identification of objects is critical.

The feature embedding vector, which is an output by the image encoder 410, encapsulates the semantic and contextual features of the tracked object. A plurality of feature embedding vectors are utilized to construct a distance matrix for batch processing the distances between pairs of images. By way of an example, the distance matrix is computed using a Mahalanobis distance or a Jaccard distance aggregation.

The Mahalanobis distance accounts for the correlations between features and scales distances. Unlike the Euclidean distance, which assumes all features contribute equally and independently to the distance calculation, the Mahalanobis distance adjusts for feature covariance, and, thereby, providing a more accurate measure of similarity between feature vectors. Accordingly, the Mahalanobis distance is particularly advantageous in high-dimensional spaces where features are interdependent and unequally informative.

In some examples, Mahalanobis distance is aggregated with the Jaccard distance to refine the ranking by the ranking module 412. The Jaccard distance measures the dissimilarity between sets of images and is effective in identifying likely true positives within the neighborhood of an object's top-n nearest neighbors identified by Mahalanobis distance.

This dual-distance approach, as disclosed herein, enhances the precision and recall of the ReID process. In pattern recognition, information retrieval, object detection and classification, precision and recall are performance metrics that apply to data retrieved from the plurality of images collected by the plurality of cameras 402a, . . . , 402n.

In some examples, the first round of ranking is performed using the Mahalanobis distance. As described herein, the first round of ranking thus identifies the top-n neighbors of the target identity based on the similarity of their feature embedding vectors. Subsequently, ranking is refined by considering the Jaccard distance. This additional measure helps in locating the likely true positives within the neighborhood of the initial top-n neighbors, thereby increasing the recall rate and improving the robustness of the re-identification process.

The combination of Mahalanobis and Jaccard distances in the re-ranking process provides a significant improvement over traditional methods that rely solely on Euclidean distance. By accounting for feature correlations and leveraging set-based dissimilarity measures, higher accuracy and recall in object re-identification are achieved. Higher accuracy and recall are crucial for applications requiring reliable and precise multi-camera tracking, such as security surveillance, traffic monitoring, and automated inspection systems.

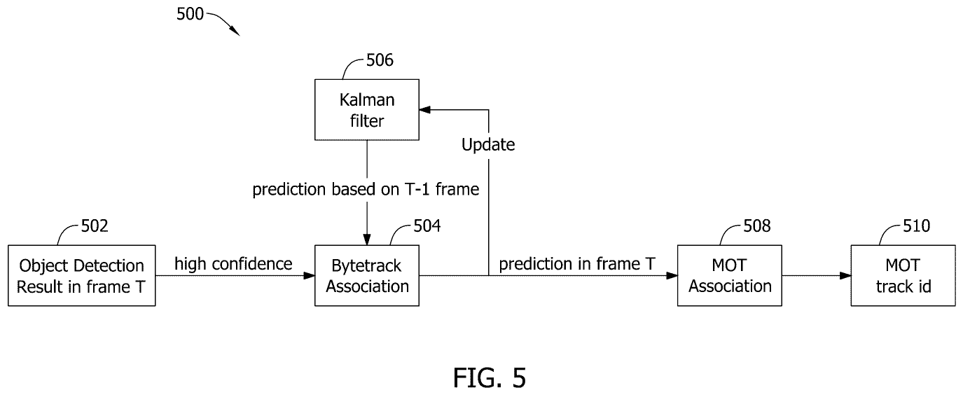

Various concepts described in FIG. 4 are described in detail below with reference to FIG. 5-FIG. 10.

FIG. 5 is a flow-chart illustrating an example process 500 of single camera MOT using ByteTrack. As described herein, the ByteTrack, or similar Ultralytics YOLO, is an open-source software for multi-object tracking model that detects, identifies, and tracks objects across video frame or multiple camera images. The ByteTrack-based multi-object tracking module initially takes object detection results as input as shown in FIG. 5 as 502. Object detections with a very low-confidence score, for example, having a confidence score below 50 percentage, are discarded, while both high-confidence score, for example, having a confidence score above 80 percentage, and low-confidence score, for example, having a confidence score not below 50 percentage and not above 80 percentage, detections are retained and input into a ByteTrack association block 504.

The ByteTrack association block 504 performs two rounds of associations. In the first round of association, bounding boxes corresponding to object detections, shown in FIG. 5 as 502, having a high-confidence score in a frame at time T are associated with the predictions of a Kalman filter 506 from a previous frame, for example, from a frame at time T−1. Using an Intersection over Union (IoU) of the bounding boxes, ByteTrack association block 504 applies the Hungarian algorithm to determine the best match between the detected bounding boxes 502 and the predictions of the Kalman filter 506 based upon the distance calculation algorithm such as, shortest distance between the detected bounding boxes 502 and the predictions of the Kalman filter 506.

In certain embodiments, matches with high IoU are retained to update the Kalman filter matrix. During the second round of association, object detections having a low-confidence score are matched with the remaining unmatched object detection predictions to capture scenarios where the tracked object is occluded or blurred due to motion or other reasons.

Based upon the two rounds of association within the ByteTrack association module 504, the ByteTrack association module 504 selects reliable tracking-detection matches to update the Kalman filter 506. The updated Kalman filter 506 then generates predictions for the current frame at time T. Subsequently, the MOT association module 508 links the detections in the current frame at time T with the tracking predictions to assign consistent tracking IDs 510 to each detected identity.

Accordingly, the ByteTrack-based MOT primarily tracks objects based on motion information. By way of an example, the ByteTrack-based MOT has certain advantages over other MOT solutions such as DeepSORT, which requires multiple rounds of associations. Unlike DeepSORT, which filters out low-confidence score detections initially, ByteTrack retains low-confidence score detections, as the low-confidence score detections correspond to occluded or blurred objects due to motion. Further, ByteTrack addresses ID switches in dense tracking scenarios more effectively.

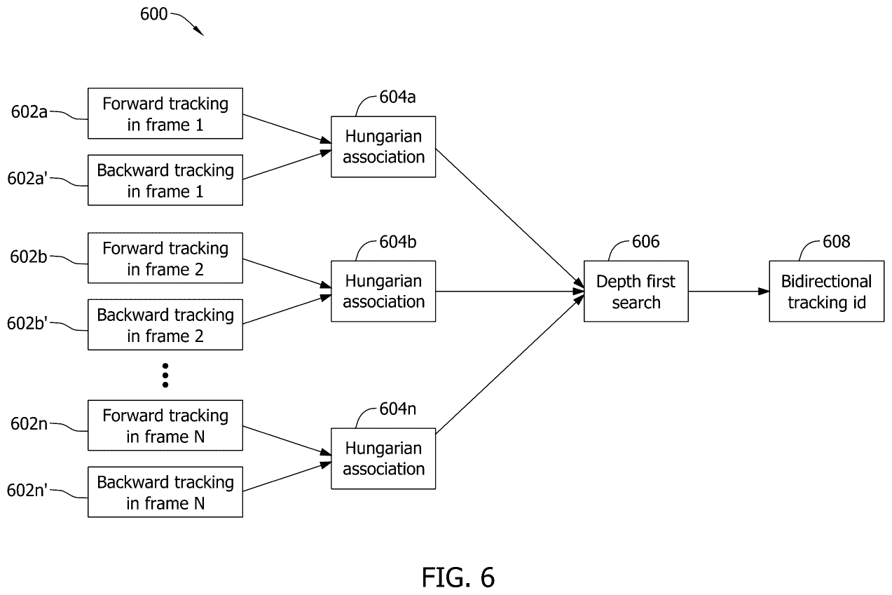

FIG. 6 is a diagram illustrating an example process of single camera MOT using ByteTrack for bidirectional ReID. As described herein, the bidirectional ReID methodology includes two distinct rounds of tracking, for example, a forward tracking and a backward tracking. Tracking based upon the two rounds is an inherent limitation of single MOT systems, which are predicated on Kalman filtering techniques. In the initial frames of Kalman filtering, the covariance matrix, and associated parameters (e.g., state transition matrix, process noise covariance) are not sufficiently updated to accurately reflect the real motion dynamics of the tracked object within the image plane. Consequently, there exists a period of unstable tracking in the initial forward tracking phase, which is subsequently stabilized in the backward tracking phase, and vice versa.

In a first step, referenced herein as dual-round tracking, during forward tracking, the initial tracking sequence is performed in the standard chronological order, and during backward tracking, the tracking sequence is performed or executed in reverse chronological order, thereby stabilizing periods that were initially unstable during forward tracking. The dual-round tracking is performed for each frame. Dual-round tracking for frame 1 is shown in FIG. 6 by 602a and 602a′ corresponding to forward tracking and backward tracking, respectively. Similarly, dural-round tracking for frame 2 is shown in FIG. 6 by 602b and 602b′ corresponding to forward tracking and backward tracking, and for frame n by 602n and 602n′ corresponding to forward tracking and backward tracking, respectively.

In a second step, referenced herein as reindexing based upon the dual-round tracking described above with reference to the first step, following the bidirectional tracking or dual-round tracking, reindexing is conducted to integrate and reconcile the two sets of tracking results. Reindexing includes frame-level association and optimization using the Hungarian algorithm. During frame-level association, each tracking ID and corresponding bounding box from the forward and backward tracking sequences are treated as nodes in a bipartite graph. The edge weights between these nodes are determined by the Intersection over Union (IoU) metric of the respective bounding boxes. The Hungarian algorithm is employed, as shown in FIG. 6 as 604a-604n, to find an optimal match between forward and backward tracking bounding boxes, ensuring the highest possible IoU values.

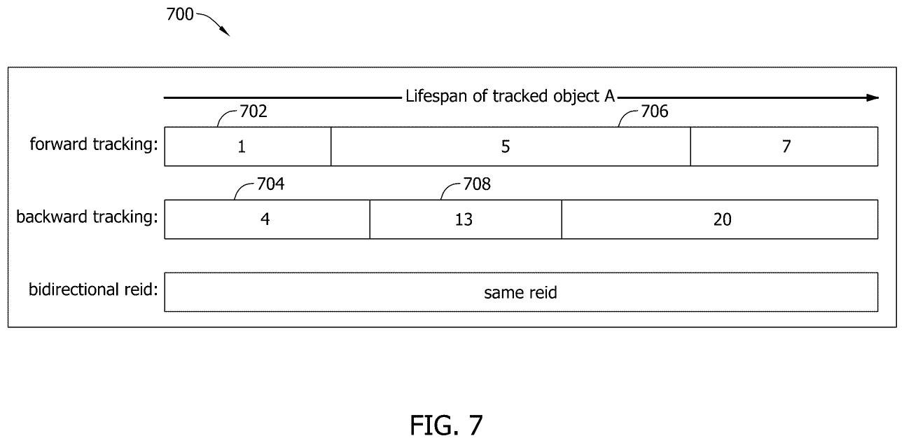

In a third step, referenced herein as a scene-level association, once frame-level associations are established, a Depth-First Search (DFS) algorithm 606 is utilized to aggregate these associations into scene-level correlations. Referring to FIG. 7, a diagram 700 illustrates the ReID improvement or association as described herein. As shown in FIG. 7, in one example, a forward tracking ID 1 at frame t1 702 maps to backward tracking ID 4 704. The backward tracking ID 4 704 at frame t2 maps to forward tracking ID 5 706 at frame t3, which maps to backward tracking ID 13 708. Using the DFS algorithm 606, these sequential associations are unified into a single consistent tracking ID across frames shown in FIG. 6 as bidirectional tracking ID 608.

The bidirectional ReID system, as described herein. significantly reduces ID switches and stabilizes tracklets. Further, by effectively addressing the initial instability in Kalman filter-based tracking, more reliable and continuous object tracking across multiple camera views is ensured, and thereby the overall robustness and accuracy of multi-camera tracking systems are enhanced.

While a process of single camera MOT using ByteTrack for bidirectional ReID is described with reference to the diagram 600 shown in FIG. 6, using the distance matrix generated from the re-ranking based on feature embedding vectors, cross-camera instance associations may be established. A multiple camera ReID based on re-ranking result process includes top neighbor matching and identity association using a union-find algorithm.

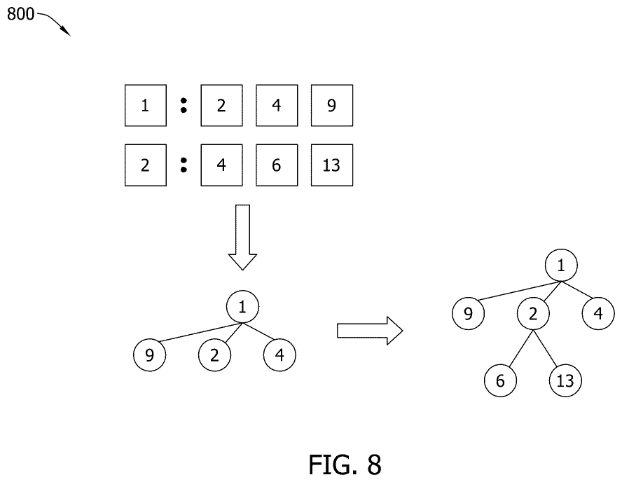

The top neighbor matching includes identification of top neighbors and distance matrix constructions. Identification of top neighbors includes identifying top three nearest neighbors based on the distance matrix. The top three nearest neighbors are identified for each target object; accordingly, for each target object, three matching pairs are identified as top-n neighbors. Next, for a given n×m distance matrix, where n is the number of target objects and m is the number of candidate neighbors, 3n matching pairs are identified. This ensures comprehensive coverage of potential matches across different camera views. Further, the union-find algorithm is employed to create union trees. Each created union tree represents a unique identity. The union-find algorithm has two primary functions-find and union. The find function determines the root of the tree that particular element belongs to, and the union function merges two trees into a single tree based upon a shared common element, as shown in a diagram 800 of FIG. 8.

As shown in the diagram 800, for example, a first instance instance-1 has three neighbor instances instance-2, instance-4, and instance-9. A second instance instance-2 has three neighbor instances instance-4, instance-6, and instance-13. By applying the union operation, a union tree is formed based upon merging the results. The union tree represents an association of all instances across the plurality of cameras and belonging to the same identity.

The union-find algorithm initializes each instance as its own unique tree, and union operations are performed to merge trees for each top-neighbor match. If two instances share a common neighbor, their respective trees are merged. The resulting union trees represent groups of instances that are identified as the same object across different camera views.

Accordingly, the integration of the re-ranking results with the union-find algorithm provides a robust mechanism for multi-camera ReID. By associating instances based on top-neighbor matching and efficiently merging them using union-find, the system can accurately identify and track objects across multiple cameras. In other words, the method disclosed herein enhances the reliability of object re-identification, making it highly suitable for applications such as surveillance, traffic monitoring, and automated security systems.

FIG. 9 illustrates a set of images 900 for two different objects (e.g., a first vehicle 902a and a second vehicle 902b) captured using a plurality of cameras 402a . . . 402n at different times. The set of images includes a first set of images 902a′ and a second set of images 902b′ corresponding to the first vehicle 902a and the second vehicle 902b, respectively.

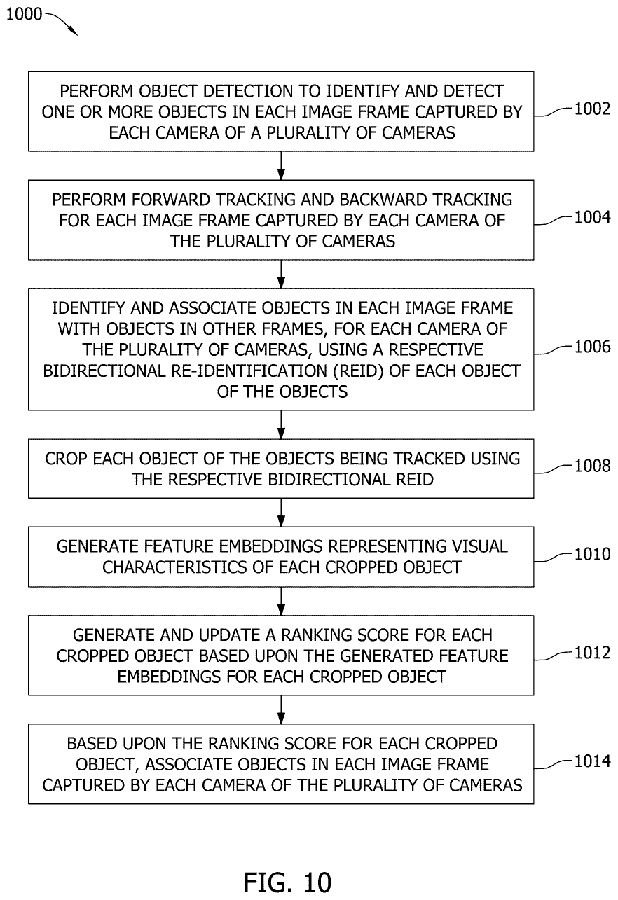

FIG. 10 is a flow-chart of an example method 1000 of object association in a plurality of images captured by a plurality of cameras. The method 1000 includes performing 1002 object detection to identify and detect one or more objects in each image frame captured by each camera of a plurality of cameras. As described herein, performing 1002 object detection to identify and detect one or more objects in each image frame captured by each camera of a plurality of cameras includes performing object tracking, using a multi-object tracking model, for each image captured by each camera of the plurality of cameras by estimating one or more bounding boxes and identity of the one or more objects in each image captured by each camera of the plurality of cameras.

Additionally, or alternatively, performing 1002 object detection to identify and detect one or more objects in each image frame captured by each camera of a plurality of cameras includes selecting, based upon a confidence score value assigned to each of the identified one or more objects, from the one or more objects, objects having the confidence score value that meets a first predetermined condition for the confidence score value, calculating distance, the IoU method, between the remaining unassociated objects in the frame at time T having the confidence score value that meets the second predetermined condition for the confidence score value and remaining unassociated objects predicted in the frame at time T−1, and associating, based upon the calculated distance, the remaining unassociated objects in the frame at time T with the remaining unassociated objects predicted in the frame at time T−1. The objects are predicted at time T−1 using a Kalman filter, as described herein.

Additionally, or alternatively, performing 1002 object detection to identify and detect one or more objects in each image frame captured by each camera of a plurality of cameras includes selecting, based upon a confidence score value assigned to each of the identified one or more objects, from the one or more objects, remaining unassociated objects having the confidence score value that meets a second predetermined condition for the confidence score value. Further, distance between the remaining unassociated objects in the frame at time T having the confidence score value that meets the second predetermined condition for the confidence score value and remaining unassociated objects predicted in the frame at time T−1 is calculated or computed using the IoU method, and, based upon the calculated distance, the remaining unassociated objects in the frame at time T are associated with the remaining unassociated objects predicted in the frame at time T−1.

The method 1000 includes performing 1004 forward tracking and backward tracking for each image frame captured by each camera of the plurality of cameras, as described in detail herein, and identifying and associating 1006 objects in each image frame with objects in other frames, for each camera of the plurality of cameras, using a respective bidirectional re-identification (ReID) of each object of the objects. As described herein, frame-level association of respective bounding boxes is performed for each object of the objects using a Hungarian algorithm for identifying and associating objects in each image frame with objects in other frames, for each camera of the plurality of cameras, using the respective bidirectional re-identification (ReID) of each object of the objects.

The method 1000 includes cropping 1008 each object of the objects being tracked using the respective bidirectional ReID and generating 1010 feature embeddings representing visual characteristics of each cropped object, as described herein, for generating and updating 1012 a ranking score for each cropped object based upon the generated feature embeddings for each cropped object. Further, the method 1000 includes associating 1014 objects in each image frame captured by each camera of the plurality of cameras based upon the ranking score for each cropped object by establishing an association of the objects in each image frame captured by each camera of the plurality of cameras based upon top-n number of neighbor matching and a union-find algorithm. Additionally, the ranking score for each cropped object is generated and updated, based upon the generated feature embeddings for each cropped object and using a Mahalanobis distance or the Mahalanobis distance aggregated with a Jaccard distance.

An example technical effect of the methods, systems, and apparatus described herein includes at least accurately identifying and tracking objects across multiple cameras. In other words, the method disclosed herein enhances the reliability of object re-identification, making it highly suitable for applications such as surveillance, traffic monitoring, and automated security systems, and calculating distance, using Intersection over Union (IoU) method, between the objects in a frame at time T having the confidence score value that meets the first predetermined condition for the confidence score value and objects predicted in a frame at time T−1. Based upon the calculated distance, the objects in the frame at time T are associated with the objects predicted in the frame at time T−1.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A system comprising:
at least one memory configured to store machine executable instructions; and
at least one processor coupled to the at least one memory and configured to execute the machine executable instructions to:
perform object detection to identify and detect one or more objects in each image frame captured by each camera of a plurality of cameras;
perform forward tracking and backward tracking for each image frame captured by each camera of the plurality of cameras;
identify and associate objects in each image frame with objects in other frames, for each camera of the plurality of cameras, using a respective bidirectional re-identification (ReID) of each object of the objects;
crop each object of the objects being tracked using the respective bidirectional ReID;
generate feature embeddings representing visual characteristics of each cropped object;
generate and update a ranking score for each cropped object based upon the generated feature embeddings for each cropped object; and
based upon the ranking score for each cropped object, associate objects in each image frame captured by each camera of the plurality of cameras.

2. The system of claim 1, wherein to perform object detection to identify and detect the one or more objects in each image captured by each camera of the plurality of cameras, the at least one processor is further configured to execute the machine executable instructions to:
perform object tracking, using a multi-object tracking model, for each image captured by each camera of the plurality of cameras by estimating one or more bounding boxes and identity of the one or more objects in each image captured by each camera of the plurality of cameras.

3. The system of claim 2, wherein to perform object detection to identify and detect the one or more objects in each image captured by each camera of the plurality of cameras, the at least one processor is further configured to execute the machine executable instructions to:
based upon a confidence score value assigned to each of the identified one or more objects, select, from the one or more objects, objects having the confidence score value that meets a first predetermined condition for the confidence score value;
calculate distance, using Intersection over Union (IoU) method, between the objects in a frame at time T having the confidence score value that meets the first predetermined condition for the confidence score value and objects predicted in a frame at time T−1; and
associate, based upon the calculated distance, the objects in the frame at time T with the objects predicted in the frame at time T−1,
wherein the objects are predicted at time T−1 using a Kalman filter.

4. The system of claim 3, wherein to perform object detection to identify and detect the one or more objects in each image captured by each camera of the plurality of cameras, the at least one processor is further configured to execute the machine executable instructions to:
based upon a confidence score value assigned to each of the identified one or more objects, select, from the one or more objects, remaining unassociated objects having the confidence score value that meets a second predetermined condition for the confidence score value;
calculate distance, the IoU method, between the remaining unassociated objects in the frame at time T having the confidence score value that meets the second predetermined condition for the confidence score value and remaining unassociated objects predicted in the frame at time T−1; and
associate, based upon the calculated distance, the remaining unassociated objects in the frame at time T with the remaining unassociated objects predicted in the frame at time T−1.

5. The system of claim 1, wherein to identify and associate objects in each image frame with objects in other frames, for each camera of the plurality of cameras, using the respective bidirectional re-identification (ReID) of each object of the objects, the at least one processor is further configured to execute the machine executable instructions to:
perform frame-level association of respective bounding boxes for each object of the objects using a Hungarian algorithm.

6. The system of claim 1, wherein to associate objects in each image frame captured by each camera of the plurality of cameras, based upon the ranking score for each cropped object, the at least one processor is further configured to execute the machine executable instructions to establish an association of the objects in each image frame captured by each camera of the plurality of cameras based upon top-n number of neighbor matching and a union-find algorithm.

7. The system of claim 1, wherein to generate and update the ranking score for each cropped object based upon the generated feature embeddings for each cropped object, the at least one processor is further configured to execute the machine executable instructions to generate and update the ranking score using a Mahalanobis distance or the Mahalanobis distance aggregated with a Jaccard distance.

8. A computer-implemented method comprising:
performing object detection to identify and detect one or more objects in each image frame captured by each camera of a plurality of cameras;
performing forward tracking and backward tracking for each image frame captured by each camera of the plurality of cameras;
identifying and associating objects in each image frame with objects in other frames, for each camera of the plurality of cameras, using a respective bidirectional re-identification (ReID) of each object of the objects;
cropping each object of the objects being tracked using the respective bidirectional ReID;
generating feature embeddings representing visual characteristics of each cropped object;
generating and updating a ranking score for each cropped object based upon the generated feature embeddings for each cropped object; and
based upon the ranking score for each cropped object, associating objects in each image frame captured by each camera of the plurality of cameras.

9. The computer-implemented method of claim 8, wherein performing object detection to identify and detect the one or more objects in each image captured by each camera of the plurality of cameras comprises:
performing object tracking, using a multi-object tracking model, for each image captured by each camera of the plurality of cameras by estimating one or more bounding boxes and identity of the one or more objects in each image captured by each camera of the plurality of cameras.

10. The computer-implemented method of claim 9, wherein performing object detection to identify and detect the one or more objects in each image captured by each camera of the plurality of cameras further comprises:
based upon a confidence score value assigned to each of the identified one or more objects, selecting, from the one or more objects, objects having the confidence score value that meets a first predetermined condition for the confidence score value;
calculating distance, using Intersection over Union (IoU) method, between the objects in a frame at time T having the confidence score value that meets the first predetermined condition for the confidence score value and objects predicted in a frame at time T−1; and
associating, based upon the calculated distance, the objects in the frame at time T with the objects predicted in the frame at time T−1, wherein the objects are predicted at time T−1 using a Kalman filter.

11. The computer-implemented method of claim 10, wherein performing object detection to identify and detect the one or more objects in each image captured by each camera of the plurality of cameras further comprises:
based upon a confidence score value assigned to each of the identified one or more objects, selecting, from the one or more objects, remaining unassociated objects having the confidence score value that meets a second predetermined condition for the confidence score value;
calculating distance, the IoU method, between the remaining unassociated objects in the frame at time T having the confidence score value that meets the second predetermined condition for the confidence score value and remaining unassociated objects predicted in the frame at time T−1; and
associating, based upon the calculated distance, the remaining unassociated objects in the frame at time T with the remaining unassociated objects predicted in the frame at time T−1.

12. The computer-implemented method of claim 8, wherein identifying and associating objects in each image frame with objects in other frames, for each camera of the plurality of cameras, using the respective bidirectional re-identification (ReID) of each object of the objects comprises:
performing frame-level association of respective bounding boxes for each object of the objects using a Hungarian algorithm.

13. The computer-implemented method of claim 8, wherein associating objects in each image frame captured by each camera of the plurality of cameras, based upon the ranking score for each cropped object comprises establishing an association of the objects in each image frame captured by each camera of the plurality of cameras based upon top-n number of neighbor matching and a union-find algorithm.

14. The computer-implemented method of claim 8, wherein generating and updating the ranking score for each cropped object based upon the generated feature embeddings for each cropped object comprises generating and updating the ranking score using a Mahalanobis distance or the Mahalanobis distance aggregated with a Jaccard distance.

15. An autonomous vehicle comprising:
a plurality of image sensors;
at least one memory configured to store machine executable instructions; and
at least one processor coupled to the at least one memory and configured to execute the machine executable instructions to:
perform object detection to identify and detect one or more objects in each image frame captured by each image sensor of the plurality of image sensors;
perform forward tracking and backward tracking for each image frame captured by each image sensor of the plurality of image sensors;
identify and associate objects in each image frame with objects in other frames, for each image sensor of the plurality of image sensors, using a respective bidirectional re-identification (ReID) of each object of the objects;
crop each object of the objects being tracked using the respective bidirectional ReID;
generate feature embeddings representing visual characteristics of each cropped object;
generate and update a ranking score for each cropped object based upon the generated feature embeddings for each cropped object; and
based upon the ranking score for each cropped object, associate objects in each image frame captured by each image sensor of the plurality of image sensors.

16. The autonomous vehicle of claim 15, wherein to perform object detection to identify and detect the one or more objects in each image captured by each image sensor of the plurality of image sensors, the at least one processor is further configured to execute the machine executable instructions to:
perform object tracking, using a multi-object tracking model, for each image captured by each image sensor of the plurality of image sensors by estimating one or more bounding boxes and identity of the one or more objects in each image captured by each image sensor of the plurality of image sensors;
based upon a confidence score value assigned to each of the identified one or more objects, select, from the one or more objects, objects having the confidence score value that meets a first predetermined condition for the confidence score value;
calculate distance, using Intersection over Union (IoU) method, between the objects in a frame at time T having the confidence score value that meets the first predetermined condition for the confidence score value and objects predicted in a frame at time T−1; and
associate, based upon the calculated distance, the objects in the frame at time T with the objects predicted in the frame at time T−1,
wherein the objects are predicted at time T−1 using a Kalman filter.

17. The autonomous vehicle of claim 16, wherein to perform object detection to identify and detect the one or more objects in each image captured by each image sensor of the plurality of image sensors, the at least one processor is further configured to execute the machine executable instructions to:
based upon a confidence score value assigned to each of the identified one or more objects, select, from the one or more objects, remaining unassociated objects having the confidence score value that meets a second predetermined condition for the confidence score value;
calculate distance, the IoU method, between the remaining unassociated objects in the frame at time T having the confidence score value that meets the second predetermined condition for the confidence score value and remaining unassociated objects predicted in the frame at time T−1; and
associate, based upon the calculated distance, the remaining unassociated objects in the frame at time T with the remaining unassociated objects predicted in the frame at time T−1.

18. The autonomous vehicle of claim 15, wherein to identify and associate objects in each image frame with objects in other frames, for each image sensor of the plurality of image sensors, using the respective bidirectional re-identification (ReID) of each object of the objects, the at least one processor is further configured to execute the machine executable instructions to:
perform frame-level association of respective bounding boxes for each object of the objects using a Hungarian algorithm.

19. The autonomous vehicle of claim 15, wherein to associate objects in each image frame captured by each image sensor of the plurality of image sensors, based upon the ranking score for each cropped object, the at least one processor is further configured to execute the machine executable instructions to establish an association of the objects in each image frame captured by each camera of the plurality of cameras based upon top-n number of neighbor matching and a union-find algorithm.

20. The autonomous vehicle of claim 15, wherein to generate and update the ranking score for each cropped object based upon the generated feature embeddings for each cropped object, the at least one processor is further configured to execute the machine executable instructions to generate and update the ranking score using a Mahalanobis distance or the Mahalanobis distance aggregated with a Jaccard distance.
